(19) United States
(12) Patent Application Publication
(10) Pub. No.: US 2004/0043897 A1
(43) Pub. Date: Mar. 4, 2004

(54) Catalyst and method for the catalytic reduction of nitrogen oxides

(76) Inventor: Nakatsuji Tadao, Espoo (FI)

Correspondence Address: BIRCH STEWART KOLASCH & BIRCH, PO BOX 747, FALLS CHURCH, VA, 22040-0747, US

(21) Appl. No.: 10/380,776

(22) PCT Filed: Sep. 6, 2001
(86) PCT No.: PCT/FI01/00777

(30) Foreign Application Priority Data
Sep. 18, 2000 (FI) 20002052
Dec. 22, 2000 (FI) 20002846

(51) Int. Cl. B01D 53/94

(52) U.S. Cl. 502/302; 423/213.5; 502/325

(57) ABSTRACT

The invention provides a method for the catalytic decomposition of nitrogen oxides using periodic rich/lean excursions with a high durability even in the presence of oxygen, sulfur oxides and water and at high reaction temperatures. The invention also provides a catalyst for the catalytic decomposition of nitrogen oxides that comprises Rh and/or Pd supported on zirconium oxide, cerium oxide, praseodymium oxide and/or neodymium oxide. The catalyst may also comprise an outside layer of said catalyst type and an inner layer containing Rh, Pd and/or Pt which preferably is supported on an inorganic oxide.

### FIELD OF THE INVENTION

This invention relates to a method for the catalytic reduction of nitrogen oxides. More particularly, the invention relates to a method for the catalytic reduction of nitrogen oxides (NOx) by combusting with periodic rich/lean fuel supply excursions and contacting the resulting exhaust gases with a catalyst.

By the term “excursion” is meant a movement of the air/fuel ratio outward and back from a mean value along a time axis. By “rich” is meant an air/fuel ratio<the stoichiometric air/fuel ratio. By “lean” is meant an air/fuel ratio>the stoichiometric air/fuel ratio of the fuel in question.

Nitrogen oxides contained in exhaust gases have been removed by, for example, a method in which the nitrogen oxides are oxidized and then absorbed in an alkali or a method in which the nitrogen oxides are reduced to nitrogen by using ammonia, hydrogen, carbon monoxide or hydrocarbons as a reducing agent. These conventional methods have their own disadvantages. That is, the former method requires a means for handling the resulting alkaline waste liquid to prevent environmental pollution. The latter method, when it uses ammonia as a reducing agent, involves the problem that ammonia reacts with sulfur oxides in the exhaust gases at a lower temperature to form salts, resulting in a reduction in catalytic activity. When the latter method uses hydrogen, carbon monoxide or hydrocarbons as a reducing agent, the reducing agent preferentially reacts with oxygen because the exhaust gas from lean burnt engines contains oxygen in a higher concentration than nitrogen oxides. This means that substantial reduction of nitrogen oxides requires a large quantity of the reducing agent.

It was proposed to catalytically decompose nitrogen oxides in the absence of a reducing agent. However, known catalysts fort direct decomposing of nitrogen oxides have not yet been put to practical use due to their low decomposing activity. On the other hand, a variety of zeolites were proposed as a catalyst for catalytic reduction of nitrogen oxides using a hydrocarbon or an oxygen-containing organic compound as a reducing agent. In particular, Cu-ion exchanged ZSM-5 or H type (acid type) zeolite ZSM-5 (SiO₂/Al₂O₃ molar ratio=30 to 40) are regarded optimal. However, it was found that not even the H type zeolite ZSM-5 has sufficient reducing activity at a practical space velocity. In particular, the zeolite catalyst was deactivated quickly on account of dealumination of the zeolite structure when water was contained in the exhaust gas.

Under these circumstances, it has been necessary to develop a more active catalyst for the catalytic reduction of nitrogen oxides. Accordingly, a catalyst composed of an inorganic oxide carrier material having silver or silver oxide supported thereon has recently been proposed, as described in EP-A1-526 099 and EP-A1-679 427, corresponding to Japanese Patent Application Laid-open No. 5-317647. However, it has been found that the catalyst has a high activity for oxidation whereas it has a low selective reactivity to nitrogen oxides, so that the catalyst has a low conversion rate of nitrogen oxides to nitrogen. In addition, the catalyst involves the problem that it is deactivated rapidly in the presence of sulfur oxides. These catalysts catalyze the selective reduction of NOx with hydrocarbons under full lean conditions. However, the lower NOx conversions and narrower temperature windows compared to the conventional three-way catalysts, which simultaneously eliminate CO, NOx and hydrocarbons, make it difficult for the lean NOx catalysts to be practically used. Thus, there has been a demand for developing a more heat-resistant and active catalyst for the catalytic reduction of nitrogen oxides.

In order to overcome these problems, a NOx storage-reduction system has recently been proposed as one of the most promising methods, as described in Society of Automotive Engineers (SAE) Paper 950809. In the proposed system (Toyota), fuel is periodically for a short moment spiked into a combustion chamber in excess of the stoichiometric amount. Vehicles with lean burn engine can be driven at lower consumption rates than conventional vehicles. It is because such vehicles can be driven using a much lower fuel/air ratio than the conventional vehicles. This so called NOx storage-reduction system reduces NOx (N+NO₂) in periodic two steps at intervals of one to two minutes. In the first step under lean conditions, NO is oxidized into NO₂ on a Pt catalyst, and the NO₂ is adsorbed on such alkali compounds as K₂CO₃ and BaCO₃. Subsequently, in the second step, the conditions are changed into rich conditions and the rich conditions are maintained for several seconds. Under the rich conditions, the adsorbed NO₂ is effectively reduced into N₂ with hydrocarbons, CO and H₂ on a Pt and/or Rh catalyst. This system of NOx storage-reduction works well for a long period in the absence of sulfur oxides (SOx). However, in the presence of SOx, the system deteriorates drastically due to the irreversible adsorption of SOx on the NO₂ adsorption sites under both lean and rich conditions.

### SUMMARY OF THE INVENTION

It is an object of the invention to provide a method for the catalytic decomposition of NOx contained in exhaust gases to nitrogen and oxygen by combusting with periodic rich/lean excursions and contacting the resulting exhaust gases with a catalyst. The method has a high durability even in the presence of oxygen, sulfur oxides and water and at high reaction temperatures. In the lean excursion, i.e., under oxidizing conditions, nitrogen oxides are selectively decomposed into nitrogen and oxygen over a reduced catalyst after a rich excursion whereby the reduced catalyst can be gradually oxidized by the formed oxygen and oxygen in exhaust gases. In the rich excursion, i.e. under reducing conditions, the oxidized catalyst is reduced, i.e., regenerated efficiently without injecting a large quantity of fuel.

It is a further object of the invention to provide a highly durable catalyst for the catalytic decomposition of nitrogen oxides to nitrogen and oxygen in the periodic lean and rich excursion with a wide temperature window even in the presence of SOx, oxygen and water.

The invention relates to a method for the catalytic decomposition of nitrogen oxides in exhaust gases by combusting with periodic rich/lean fuel supply excursions and contacting the resulting exhaust gases with a catalyst. The excursions consist of a continuous lean fuel supply essentially interrupted by small rich pulses, the time span of which are from 0.5 to 10 seconds and constitute from 0.5 to 10% of the combined lean and rich time span. The claimed method's catalyst comprises a first compound, selected from rhodium, palladium, rhodium oxide, palladium oxide and mixtures thereof, preferably rhodium or rhodium oxide, and a second compound, selected from zirconia, cerium oxide, praseodymium oxide and/or neodymium oxide, preferably zirconia, as well as mixtures thereof.

The term “comprises” in this document means that the disclosed components must be present, but that further components may also be present (Grubb, Ph. W., Patents in Chemistry and Biotechnology, 1986, p. 220).

### DETAILED DESCRIPTION OF THE INVENTION

First Main Embodiment

According to a first main embodiment of the invention, in the catalyst, the combined amount of said first and said second compound is at least 80%, preferably at least 95%, based on the combined weight of the catalyst. In the catalyst, the amount of said first compound is preferably 0.05-3% by weight in terms of rhodium and/or palladium, based on the combined weight of said first and said second compound.

In the catalyst according to the the first main embodiment of the present invention, at least a part of said second compound preferably supports said first compound. According to a first variation of the first main embodiment, essentially all of said second compound supports all of said first compound. According to a second variation of the first main embodiment, a part of said second compound supports said first compound and another part of said second compound does not support said first compound. According to a third variation of the first main embodiment, a part of said second compound supports said first compound and another part of said second compound is supported by said first compound. Thus, the third variation means a catalyst according to the first variation at least partly coated with or covered by a layer of said second compound.

The second compound used in the catalyst of the first main embodiment plays a role not only as a carrier material to support the first compound, but also as a promoter to enhance the reduction of Rh and/or Pd oxides to Rh and/or Pd metals in rich operations and suppress the oxidation from Rh and/or Pd metals to Rh and/or Pd oxides in general. The third variation, i.e. part of the second compound supporting the first compound supporting another part of the second compound suppresses the oxidation from Rh and/or Pd metals to Rh and/or Pd oxides better than the first variation, i.e. the second compound supporting the first compound, resulting in an improvement of the NOx reduction selectivity.

The second compound, which is zirconia, cerium oxide, praseodymium oxide and/or neodymium oxide, may be obtained by neutralizing and/or thermally hydrolyzing at least one salt of zirconium, cerium, praseodymium and/or neodymium, such as zirconium dinitrate oxide (ZrO(NO₃)₂.nH₂O), cerium nitrate (Ce(NO₃)₃.6H₂O), praseodymium nitrate (Pr(NO₃)₃.6H₂O) and neodymium nitrate (Nd(NO₃)₃.6H₂O), followed by drying and calcining in air. Zirconium hydroxide, cerium hydroxide, praseodymium hydroxide and/or neodymium hydroxide, such as Zr(OH)₄, ZrO(OH)₂.nH₂O, Ce(OH)₃, Ce(OH)₄, Pr(OH)₃ and/or Nd(OH)₃, can be preferably be used directly as a precursor. Then, the Rh and/or Pd ions of the first compound are easily exchanged with the H⁺ of the hydroxides, resulting in high dispersion of Rh and/or Pd on the second compound.

According to the invention, there are preparation methods for producing a catalyst according to said first variation comprising Rh and/or Pd metal and/or metal oxide (=said first compound) supported on zirconia, cerium oxide, praseodymium oxide and/or neodymium oxide (=said second compound). A preferred method for producing such a catalyst comprises supporting at least one Rh and/or Pd water soluble salt such as a nitrate upon said second compound or a precursor thereof, and then calcining the resultant product in an oxidative or reductive atmosphere at a temperature of 300-900° C. The salt is applied by a conventional method such as impregnation and ion-exchange.

In more detail, an aqueous slurry of zirconium hydroxide, cerium hydroxide, praseodymium hydroxide and/or for neodymium hydroxide is e.g. first prepared. Then, a water soluble salt of Rh and/or Pd such as Rh and/or Pd nitrate is added to the slurry to fix Rh and/or Pd ions at ion exchange sites of the hydroxide(s) while the slurry is maintained at a pH around 4.0 where Rh and/or Pd hydroxide is not formed. Further, the ion-exchanged hydroxide having Rh and/or Pd ions is washed with water to remove excess nitrate ions therefrom, to provide a catalyst which supports Rh and/or Pd thereon. The resulting product is then calcined in an oxidative or reductive atmosphere such as in air or hydrogen at a temperature of 300-900° C., preferably at a temperature of 400-600° C., to form metal and/or metal oxide of Rh and/or Pd on the zirconia, cerium oxide, praseodymium oxide and/or neodymium oxide, resulting in a powdery first variation catalyst.

The catalyst of the first variation of the first main embodiment preferably contains Rh and/or Pd in the form of metal and/or metal oxide in an amount of 0.05-3% by weight in terms of metal based on the total of said first and second compound. When the amount of Rh and/or Pd in the catalyst is more than 3% by weight, the resulting catalyst has an excessive oxidation capacity of NO into NO₂ and of Rh and/or Pd into Rh and/or Pd oxides so that it is insufficient in selectivity of catalytic reaction of NO decomposition in the lean excursion. When the amount of Rh and/or Pd in the catalyst is less than 0.05% by weight, the resulting catalyst has an insufficient activity in the catalytic reaction. It is in particular preferred that the catalyst contains Rh and/or Pd in an amount of 0.1-1.5% by weight, since the use of this catalyst permits the rapid reduction of Rh and/or Pd oxides into Rh and/or Pd in the rich excursion and the catalytic decomposition of nitrogen oxides for a long time in the lean excursion to proceed with the least dependence on space velocity.

According to the invention, there are preparation methods for producing catalyst a according to said second variation of the first main embodiment comprising on one hand a Rh and/or Pd metal and/or metal oxide (said first compound) supported on zirconia, cerium oxide, praseodymium oxide and/or neodymium oxide (a first part of said second compound) and on the other hand zirconia, cerium oxide, praseodymium oxide and/or neodymium oxide (a second part of said second compound). In practice, this embodiment is a more or less intimate mixture of on one hand said first compound supported on the first part of said second compound and on the other hand the second part of said second compound as such.

A preferred method for producing a catalyst according to said second variation comprises supporting one or more water soluble salts of Rh and/or Pd such as nitrate on the first part of said second compound and then calcining the resultant product in an oxidative or reductive atmosphere at a temperature of 300-900° C. The salt is applied by a conventional method such as impregnation and ion-exchange. After this, at least one member selected from the group consisting of solid zirconia, cerium oxide, cerium hydroxide, praseodymium oxide, praseodymium hydroxide, neodymium oxide and neodymium hydroxide is mixed with a water slurry containing the Rh and/or Pd metal and/or metal oxide on the zirconia, cerium oxide, praseodymium oxide and/or neodymium oxide, followed by drying and calcining the resultant product in an oxidative or reductive atmosphere at a temperature of 300-900° C.

In more detail, an aqueous slurry of a zirconium hydroxide, cerium oxide, praseodymium oxide and/or neodymium oxide is first prepared. A water soluble salt of Rh and/or Pd such as Rh and/or Pd nitrate is added to the slurry to fix Rh and/or Pd ions at ion exchange sites of the zirconium hydroxide, cerium oxide, praseodymium oxide and/or neodymium oxide while the slurry is maintained at a pH around 4.0 where Rh and/or Pd hydroxide is not formed. Then the ion-exchanged hydroxide with Rh and/or Pd ions is washed with water to remove excess nitrate ions therefrom, to provide a catalyst in which Rh and/or Pd is/are supported thereon. The resulting product is then calcined in an oxidative or reductive atmosphere such as in air or hydrogen at a temperature of 300-900° C., preferably at a temperature of 400-600° C., to form a powdery catalyst of Rh and/or Pd metal and/or metal oxide on the zirconia, cerium oxide, praseodymium oxide and/or neodymium oxide.

After this, at least one member selected from the group consisting of zirconium hydroxide, cerium hydroxide, praseodymium hydroxide and neodymium hydroxide is mixed with a water slurry consisting of said Rh and/or Pd metal and/or metal oxide on the zirconia, cerium oxide, praseodymium oxide and/or neodymium oxide, followed by drying and calcining the resultant product in an oxidative or reductive atmosphere at a temperature of 300-900° C., to give the catalyst according to said second variation

In said second variation catalyst, the component having the first compound supported on the first part of said second compound contains Rh and/or Pd in the form of metal and/or metal oxide in an amount of 0.05-3% in terms of metal based on the combined weight of the first compound and the first part of the second compound. When the amount of Rh and/or Pd in the catalyst is more than 3% by weight, the resulting catalyst has an excessive oxidation capacity of NO into NO₂ and of Rh and/or Pd into Rh and/or Pd oxides so that it is insufficient in selectivity of the catalytic reaction of NO decomposition in the lean excursion. When the amount of Rh and/or Pd in the catalyst is less than 0.05% by weight, the resulting catalyst has an insufficient activity in the catalytic reaction.

In said second variation catalyst, it is in particularly preferred that the component having the first compound supported on the first part of said second compound contains Rh and/or Pd in the form of metal and/or metal oxide in an amount of 0.1 -1.5% by weight in terms of Rh and/or Pd, since the use of this catalyst permits the rapid reduction of Rh and/or Pd oxides into Rh and/or Pd in the rich excursion and the catalytic decomposition of nitrogen oxides for a long time in the lean excursion to proceed with the least dependence on space velocity,

Furthermore, the second variation catalyst preferably contains non-supporting zirconia, cerium oxide, praseodymium oxide and/or neodymium oxide (=the second part of the second compound) in an amount of 5-30% by weight in terms of zirconia, cerium oxide, praseodymium oxide and/or neodymium oxide, based on the total weight of the first and second compounds. When the amount of the second part of the second compound in the catalyst is more than 30% by weight, the resulting catalyst has an insufficient activity in the catalytic reaction of NO decomposition in the rich/lean excursions. When the amount of the second part of the second compound in the catalyst is less than 5% by weight, the resulting catalyst does not have an improvement in the reaction selectivity.

According to the invention, there are preparation methods for producing the above-described third variation (of the first main embodiment) catalyst comprising zirconia, cerium oxide, praseodymium oxide and/or neodymium oxide (=the second part of the second compound) further supporter d on Rh and/or Pd metal and/or metal oxide (=the first compound) supported on zirconia, cerium oxide, praseodymium oxide and/or neodymium oxide (=the first part of the second compound), i.e. an at least three layer catalyst (a ABA sandwich).

A preferred method for producing said third variation catalyst comprises (1) applying at least one member selected from the group consisting of Rh and Pd water soluble salts such as a nitrate on the first part of said second compound, and then calcining the resultant product in an oxidative or reductive atmosphere at a temperature of 300-900° C. to form the first compound supported on the first part of the second compound. The water soluble salt is applied by a conventional method such as impregnation and/or ion-exchange. Then (2) at least one member selected from the group consisting of zirconium hydroxide, cerium hydroxide, praseodymium hydroxide and neodymium zirconium hydroxide is further applied on the first compound supported on the first part of the second compound. Finally, the resultant product is calcined in an oxidative or reductive atmosphere at a temperature of 300-900° C.

In more detail, an aqueous slurry of zirconium hydroxide, cerium hydroxide, praseodymium hydroxide and/or neodymium hydroxide is prepared A water soluble salt of Rh and/or Pd such as a nitrate is added to the slurry to fix Rh and/or Pd ions at ion exchange sites of the hydroxide(s) while the slurry is maintained at a pH around 4.0 where Rh and/or Pd hydroxide is not formed. Then the ion-exchanged hydroxide with Rh and/or Pd ions is washed with water to remove excess nitrate ions therefrom, to provide a catalyst which supports Rh and/or Pd thereon. The resulting product is then calcined in an oxidative or reductive atmosphere such as in air or hydrogen at a temperature of 300-900° C., preferably at a temperature of 400-600° C., to from an Rh and/or Pd metal and/or metal oxide (=the first compound) on the zirconia, cerium oxide, praseodymium oxide and/or neodymium oxide (=the first part of the second compound), resulting in a powdery third embodiment catalyst precursor. After this, a solution of a zirconia, cerium oxide, praseodymium oxide and/or, neodymium oxide precursor is added into the water slurry containing the first compound supported on the first part of the second compound, followed by hydrolyzing, drying and calcining the resultant product in an oxidative or reductive atmosphere at a temperature of 300-900° C. to yield the third variation catalyst.

The third variation catalyst contains Rh and/or Pd in metal and/or metal oxide form in an amount of 0.05-3% by weight in terms of metal based on the combined weight of the first compound and the first part of the second compound. When the amount of Rh and/or Pd in the catalyst is more than 3% by weight, the resulting catalyst has an excessive oxidation capacity of NO into NO₂ and of Rh and/or Pd into Rh and/or Pd oxides so that it is insufficient in selectivity of the catalytic NO decomposition in the lean excursion. When the amount of Rh and/or Pd in the catalyst is less than 0.05% by weight, the resulting catalyst has an insufficient activity in the catalytic reaction.

It is in particular preferred that the catalyst of the third variation contains Rh and/or Pd in metal and/or metal oxide form in an amount of 0.1-1.5% by weight in terms of the metals; based on the combined weight of the first compound and the first part of the second compound, since the use of this catalyst permits the rapid reduction of Rh and/or Pd oxides into Rh and/or Pd in the rich excursion and the catalytic decomposition of nitrogen oxides for a long time in the lean excursion to proceed with the least dependence on space velocity.

Furthermore, the third variation catalyst contains supported zirconia, cerium oxide, praseodymium oxide and/or neodymium oxide (=the second part of the second compound) in an amount of 5-30% by weight in terms of zirconia and/or zirconia based on the combined weight of the Rh and/or Pd metal and/or metal oxide layer and the zirconia, cerium oxide, praseodymium oxide and/or neodymium oxide layer supported thereon. When the amount of the second part of the second compound is more than 30% by weight, the resulting catalyst has an insufficient activity in the catalytic reaction of NO decomposition in the rich/lean excursions. When the amount of the second part of the second compound is less than 5% by weight, the resulting catalyst does not have an improvement in the reaction selectivity

The catalyst according to the first main embodiment may be obtained in various shapes such as a honeycomb structure, a powder or particles. Accordingly, it may be molded into various shapes such as honeycomb, annular or spherical shapes by any of well-known methods. If desired, appropriate additives, such as molding additives, reinforcements, inorganic fibers or organic binders may be, used when the inner catalyst layer is molded, followed by wash-coating with the outer catalyst layer. The catalyst system of the invention may advantageously be applied onto an inactive substrate of any desired shape by, for example, a two-step wash coat method to provide a catalyst structure which has a layer of the catalyst on its surface. The inactive substrate may be composed of, for example, a clay mineral such as cordierite or a metal such as stainless steel, preferably of heat-resistant, such as a Fe—Cr—Al steel, and may be in the form of honeycomb, annular or spherical structures.

It is especially preferred that the thickness of the first main embodiment catalyst layer is ranging from 20 to 200 μm from the surface of the substrate structure so that the resulting catalyst structure is highly active in the catalytic reduction of nitrogen oxides in the rich/lean excursions. In general, if the catalyst layer is more than 200 μm in thickness, the catalyst structure has no corresponding improvement in reactivity. Furthermore, it is not desirable from the standpoint of production cost to form such a thick catalyst layer. If the catalyst layer has a thickness of lower than 20 μm, the resulting catalyst structure has insufficient activity in the NOx reduction using rich/lean excursions, because NO is oxidized into NO₂ on the inner layer catalyst in the lean operation.

In turn, the catalyst layer may be shaped into a catalyst structure of, for example, honeycomb, annular or spherical forms. By way of example, a mixture of powder catalyst layer material and an organic binder is prepared, kneaded and formed into a honeycomb structure. The honeycomb structure is then dried and calcined. These catalyst structures in the form of honeycomb prepared as above mentioned contains said catalyst layer component. It is preferred that the honeycomb structure has walls of not less than 40 μm thick so that the catalyst is contained in a layer of not less than 20 μm in depth from either surface of the walls of the catalyst structure.

Second Main Embodiment

According to a second main embodiment of the invention, the catalyst of the invention comprises

a) an outer layer catalyst containing said first compound, selected from rhodium, palladium, rhodium oxide, palladium oxide and mixtures thereof, and said second compound, selected from zirconia, cerium oxide; praseodymium oxide; neodymium oxide and mixtures thereof, and

b) an inner layer catalyst containing a third compound selected from rhodium, platinum, palladium, rhodium oxide, platinum oxide, palladium oxide and mixtures thereof.

By “outer layer” is in its widest meaning meant a layer which comes into contact with the exhaust gas before the “inner layer”. Thus, it may e.g. be an upstreams layer through which the exhaust gas passes, any downstreams layer being formed by the “inner layer”. Preferably, however, the “outer layer” is a layer which alone comes into immediate contact with the exhaust gas, e.g. the surface layer of a channel wall, body or particle also containing the “inner layer”.

In the following, the method and the catalyst according to the second main embodiment of the invention will be described in more detail. The subject matter relating to the catalyst applies for the claimed process. When talking about the preparation of the inner and outer layer, the patentee also means the corresponding inner and outer layer materials, e.g. powders.

Preferably the amount of the outer layer material is 10-95% by weight, most preferably about 50-80% by weight, of the combined weight of the inner and outer layer materials.

The catalyst preferably is a two-layer structure, the outer catalyst layer forming the outer surface of the structure and the inner catalyst layer being immediately inside said outer catalyst layer.

The inner catalyst layer of said second main embodiment preferably contains a support for said third compound. The third compound preferably consists of both platinum and/or platinum oxide and a compound selected from rhodium, palladium, rhodium oxide and palladium oxide, i.e. a combination containing both platinum and the other metals.

In the inner catalyst layer, which can eliminate the three components CO, hydrocarbons and NOx under stoichiometric air/fuel conditions, the amount of said platinum, rhodium, palladium, an oxide of them, and/or a mixture thereof, is preferably 0.05-5% by weight in terms of the metal(s), based on the combined weight of metal(s) and/or metal oxide(s) and, if used, said preferred support. Most preferably, said inner catalyst layer material is a powder, the metal(s) or its (their) compound(s) of which is (are) supported on an inert organic oxide, such as alumina, silica, silica-alumina; titania and/or zeolite, or a mixture thereof. The powder is then formed into said inner layer.

The inner catalyst layer according to the second main embodiment of the present invention plays an important role to enhance the velocity of adapting the catalyst to the change of the reaction atmosphere from lean to rich conditions and the reduction of NOx in the rich excursion. According to the invention, the inner catalyst layer powder can be prepared by conventional methods such as wet-impregnation and ion-exchanging using water soluble rhodium, platinum and palladium salts like rhodium nitrate (Rh(NO3)), tetra-ammonium platinum nitrate (P(NH₃)₄(NO₃)₂, and palladium nitrate (Pd(NO₃)₃).

According to the invention, there are preparation methods for producing the inner catalyst layer powder of the second main embodiment. A preferred method comprises applying water soluble salts of Pt, Rh, Pd or mixtures thereof such as a nitrate on a said support, and then calcining the resultant product in an oxidative or reductive atmosphere at a temperature of 300-900° C. to form said inner powder catalyst layer. The water soluble salts are applied by a conventional method such as impregnation and ion-exchange.

The inner catalyst layer of the second embodiment preferably contains Pt, Rh, Pd, an oxide or a mixture thereof in the form of metal and/or oxide in an amount of 0.05-5% by weight in terms of metal based on the total of said support and said metal and/or metal oxide supported thereon. When such amount of said metal, metal oxide, or mixture thereof in the inner catalyst layer is more than 5% by weight in terms of Pt, Rh, Pd, or a mixture thereof, the resulting inner catalyst layer has is insufficient in selectivity of the catalytic reaction of NO with reductants present in the rich excursion. When the amount of Pt, Rh, Pd, an oxide or a mixture thereof in the catalyst is less than 0.05% by weight in terms of metal, the resulting catalyst has an insufficient activity in the catalytic reaction for changing reaction atmospheres from lean to rich conditions and in the reacting of NO with reductants present. It is in particular preferred that the inner catalyst layer contains Pt, Rh, Pd, or a mixture thereof in an amount of 0.1-3% by weight in terms of metal.

In the outer catalyst layer, the combined amount of said first and said second compound is at least 80% , preferably at least 95% , based on the total weight of the outer catalyst layer. In the outer catalyst layer, the amount of said first compound is preferably 0.05-3% by weight in terms of rhodium and/or palladium, based on the combined weight of said first and said second compound.

In the outer catalyst layer, at least a part of said second compound preferably supports said first compound. The layer structure of the outer catalyst layer may be any one as described for the first main embodiment. Most preferably, essentially all of said second compound supports all of said first compound. The second compound used in the outer catalyst layer plays a role not only as a carrier material to support Rh and/or Pd metal and/or metal oxide, but also as a promoter to enhance the reduction of Rh and/or Pd oxides to Rh and/or Pd metals in rich operations and suppress the oxidation from Rh and/or Pd metals to Rh and/or Pd oxides in general.

At least one member selected from the group consisting of zirconia, cerium oxide, praseodymium oxide and neodymium oxide may be obtained by neutralizing and/or thermally hydrolyzing essentially as described above in connection with the first main embodiment.

A preferred method for producing said outer layer catalyst powder comprises applying at least one water soluble salts of Rh and Pd such as a nitrate on said second compound, and then calcining the resultant product in an oxidative or reductive atmosphere at a temperature of 300-900° C. to obtain said supported structure. The application of the water soluble salt(s) takes place by a conventional method such as impregnation and ion-exchange.

In more detail, an aqueous slurry of zirconium hydroxide, cerium hydroxide, praseodymium hydroxide and/or for neodymium hydroxide is prepared. A water soluble salt of Rh and/or Pd such as Rh and/or Pd nitrate is added to the slurry to fix Rh and/or Pd ions at ion exchange sites of the hydroxide(s) while the slurry is maintained at a pH around 4.0 where Rh and/or Pd hydroxide is not formed. Then the ion-exchanged hydroxide with Rh and/or Pd ions is washed with water to remove excess nitrate ions therefrom, to provide a catalyst which supports Rh and/or Pd thereon. The resulting product is finally calcined in an oxidative or reductive atmosphere such as in air or hydrogen at a temperature of 300-900° C., preferably at a temperature of 400-600° C., resulting in an outer catalyst layer material in the form of a powder. The powder is later formed into said outer catalyst layer by methods described below.

The outer layer catalyst material preferably contains Rh and/or Pd in the form of metal and/or metal oxide in an amount of 0.05-3% by weight in terms of metal based on the layers total weight of said zirconia, cerium oxide, praseodymium oxide and/or neodymium oxide and said Rh and/or Pd metal and/or metal oxide supported thereon. When the amount of Rh and/or Pd in the outer catalyst layer is more than 3% by weight, the resulting catalyst has an excessive oxidation capacity of NO into NO₂ and of Rh and/or Pd into Rh and/or Pd oxides so that it is insufficient in selectivity of catalytic reaction of NO decomposition in the lean excursion. When the amount of Rh and/or Pd in the outer catalyst layer is less than 0.05% by weight, the resulting catalyst has an insufficient activity in the catalytic reaction. It is in particular preferred that the outer catalyst layer contains Rh and/or Pd in an amount of 0.1-1.5% by weight in terms of Rh and/or Pd, since the use of such an outer catalyst layer permits the rapid reduction of Rh and/or Pd oxides into Rh and/or Pd in the rich excursion and the catalytic decomposition of nitrogen oxides for a long time in the lean excursion to proceed with the least dependence on space velocity.

Like the catalyst system of the first main embodiment the catalyst of the second main embodiment may also be obtained in various shapes such as honeycomb structure, powder, particles or contact structures. Accordingly, it may be molded into various shapes such as honeycomb, annular or spherical shapes by any of well-known methods. If desired, appropriate additives, such as molding additives, reinforcements, inorganic fibers or organic binders may be used when the inner catalyst layer is molded, followed by wash-coating with the outer catalyst layer.

The catalyst system of the second main embodiment comprising an inner and an outer catalyst layer materials, preferably in the form of, or made from, powders, may advantageously be applied onto an inactive substrate of any desired shape by, for example, a two-step wash coat method comprising an inner layer catalyst coating followed by an outer layer catalyst coating, to provide a catalyst structure which has a layer of the catalysts on the surface of it. The inactive substrate may be composed of, for example, a clay mineral such as cordierite or a metal such as stainless steel, preferably of heat-resistant, such as a Fe—Cr—Al steel, and may be in the form of honeycomb, annular or spherical structures.

It is especially preferred that the thickness of the inner catalyst layer is ranging from 10 to 80 μm (corresponding to the amounts 25 g/l to 200 g/l when using a honeycomb cordierite substrate having a cell number of 400 per square inch) from the surface of the substrate structure so that the resulting catalyst structure is highly active in the catalytic reduction of nitrogen oxides in the rich excursions. The depth or thickness of the inner catalyst layer is usually up to 40 μm (100 g/l) and it depends on the activity of the inner layer catalyst and reaction conditions. In case of a highly active inner catalyst layer, the depth can be reduced. In general, if the inner catalyst layer is more than 80 μm (200 g/l) in thickness, the catalyst structure has no corresponding improvement in reactivity. Furthermore, it is not desirable from the standpoint of production cost to form such a thick layer of inner catalyst layer. If the inner catalyst layer has a thickness of lower than 10 μm (25 g/l), the resulting catalyst structure has insufficient activity in the catalytic reaction.

It is also especially preferred that the thickness of the outer catalyst layer is ranging from 20 to 100 μm (50 g/l to 250 g/l) from the surface of the substrate structure so that the resulting catalyst structure is highly active in the catalytic reduction of nitrogen oxides in the rich/lean excursions. The depth or thickness of the outer catalyst layer is usually up to 60 μm (150 g/l). In general, if the outer catalyst layer is more than 100 μm in thickness, the catalyst structure has no corresponding improvement in reactivity. Furthermore, it is not desirable from the standpoint of production cost to form such a thick layer of outer catalyst layer. If the outer catalyst layer has a thickness of lower than 20 μm, the resulting catalyst structure has insufficient activity in the NOx reduction using rich/lean excursions, because NO is oxidized into NO₂ on the inner layer catalyst in the lean operation. Namely, the atmospheric rich or stoichiometric conditions of the inner catalyst layer cannot be maintained.

In turn, the inner catalyst layer may also be shaped into a catalyst structure of, for example, honeycomb, annular or spherical forms. By way of example, a mixture of powder inner catalyst layer material and an organic binder is prepared, kneaded and formed into a honeycomb structure. The honeycomb structure is then dried and calcined. These catalyst structures in the form of a honeycomb prepared as above mentioned contains inner catalyst layer component. After the preparation, the outer layer catalyst is additionally coated on the honeycomb-shaped inner catalyst layer. Accordingly, it is preferred that the honeycomb structure has walls of not less than 40 μm thick so that the catalyst is contained in a layer of not less than 20 μm in depth from either surface of the walls of the catalyst structure.

The catalyst of the invention (both according to the above described first and the second main embodiments) is excellent in resistance to sulfur oxides as well as resistance to heat, and it is suitable for use as a catalyst for reduction of nitrogen oxides or for denitrificating exhaust gases from diesel engines or automobile exhaust gases from lean gasoline engines.

The Process

The above described catalyst is used in catalytic NOx decomposition reaction with an oscillation between the rich and lean conditions, periodically at 5-100 seconds intervals. The time spans of the rich and lean excursion is preferably 0.5-10 seconds and 4.5-90 seconds, respectively. Preferably, the excursions consists of a continuous lean fuel supply essentially interrupted by small rich pulses, the time span of Which most preferably is from 0.5 to 10% of the combined lean/rich time span. The rich conditions are normally prepared by periodically injecting fuel into a combustion chamber of the engine at 10-14 of air/fuel ratio by weight in case of using gasoline as a fuel. The typical exhaust gases in rich conditions contain several hundred vol. ppm of NOx, 2-10% of water, 1-5% of CO, 1-5% of hydrogen, several thousands ppm of hydrocarbons and 0-0.5% of oxygen. On the other hand, the typical exhaust gases in lean conditions are composed of several hundred ppm of NOx, 2-10% of water, several thousands ppm of CO and several thousands ppm of hydrogen, several thousands ppm of hydrocarbons and 1-15%, preferably 5-10%, of oxygen.

A suitable temperature for the catalyst of the invention to have effective activity in the decomposition of nitrogen oxides for a long time in the rich excursion usually in the range of 150-500° C., preferably in the range of 200-450° C., though varying depending on the individual gas compositions used. Within the above recited temperature range, exhaust gases are preferably treated at a space velocity of 5 000-100 000 ⁻¹.

According to the method, as above described, the exhaust gas which contains nitrogen oxides is contacted with the above-described catalyst or catalyst system in the periodic rich/lean excursions. As the result, the method makes it possible to catalytically decompose nitrogen oxides into nitrogen and oxygen in the exhaust gas in a stable and efficient manner even in the presence of oxygen, sulfur oxides or moisture, with the rich/lean excursions.

The invention is now illustrated in greater detail with reference to examples; however, it should be understood that the invention is not deemed to be limited thereto. All the parts, percentages, and ratios are by weight unless otherwise indicated.

### A. FIRST MAIN EMBODIMENT (Rh, Pd/Zr, Ce, Nd, Pr oxide)

The thickness of the catalyst layers was calculated as follows:

$$Thickness ( µm ) = \frac{cw \times {10}^{2}}{Vol . \times density \times Ap}$$

, wherein cw means the coating weight in grams, Vol. is the catalyst volume in litres, density is the catalyst density in g/cm³, and Ap is the area performance of the catalyst in m²/m³. In main embodiment 1, when the coating weight per catalyst volume is about 110 g/l, the density of the layer is 1 g/cm³ and the area performance of the honeycomb or corresponding structure is 3500 m²/m³, the thickness is about 30 μm.

(1) Preparation of Catalyst

### EXAMPLE 1

In 100 ml of ion-exchanged water was dissolved 16.80 g of rhodium nitrate solution (0.90 wt % as Rh). Sixty six grams of zirconium hydroxide (RSD from Daiichi Kigenso Kagaku Kogyo) was dried at 120° C. for 24 hours, and was added to the solution of rhodium nitrate to provide a slurry. One-tenth normal (0.1 N) ammonia water was added dropwise to the slurry with stirring while the slurry was maintained at a pH of about 4 with a pH controller. After the addition, the slurry was aged for one hour, thereby providing zirconium hydroxide supporting rhodium ions thereon. The zirconium hydroxide supporting rhodium ions thereon thus obtained was collected by filtration and thoroughly washed with ion-exchanged water, thereby providing a zirconium hydroxide powder supporting rhodium thereon in an amount of 0.23% by weight in terms of rhodium based on the powder. The zirconia supporting rhodium thereon thus obtained was heated and calcined at 500° C. for three hours in air, thereby providing a zirconia powder catalyst supporting Rh metal/oxides thereon in an amount of 0.25% by weight in terms of rhodium based on the catalyst.

Sixty grams of the zirconia powder catalyst were mixed with 6 g of silica sol (Snowtex N available from Nissan Kagaku Kogyo K. K.) and an appropriate amount of water. The mixture was ground with a planetary mill for five minutes using 100 g of zirconia balls as grinding media to prepare a wash-coat slurry. A honeycomb substrate of cordierite having a cell number of 600 per square inch was coated with the slurry to provide a honeycomb catalyst structure supporting the catalyst in an amount of about 150 g/l. The thickness of the catalyst layer was about 40 μm. This catalyst is designated as Catalyst 1.

### EXAMPLE 2

A zirconia powder catalyst supporting Rh metal/oxides thereon in an amount of 0.5% by weight in terms of rhodium based on the catalyst was prepared in the same manner as in Example 1, except for using 33.60 g of the rhodium nitrate solution. The zirconia powder catalyst was supported on the same honeycomb substrate of cordierite as in Example 1 to provide a honeycomb catalyst structure supporting the catalyst in an amount of about 150 g/l. The thickness of the catalyst layer was about 40 μm. This catalyst is designated as Catalyst 2.

### EXAMPLE 3

A zirconia powder catalyst supporting rhodium thereon in an amount of 1.5% by weight in terms of rhodium based on the catalyst was prepared in the same manner as in Example 1, except for using 100.08 g of the rhodium nitrate solution. The zirconia powder catalyst was supported on the same honeycomb substrate of cordierite as in Example 1 to provide a honeycomb catalyst structure supporting the catalyst in an amount of about 150 g/l. The thickness of the catalyst layer was about 40 μm. This catalyst is designated as Catalyst 3.

### EXAMPLE 4

In 1000 ml of ion-exchanged water was dissolved 151.37 g of cerium nitrate (Ce(NO₃)₃.6H₂O). 0.1N ammonium hydroxide solution was added into the cerium nitrate solution to precipitate cerium hydroxide from cerium nitrate. After the addition, the slurry was aged for one hour. The cerium hydroxide was collected by filtration and thoroughly washed with ion-exchanged water, thereby providing a cerium hydroxide powder. A cerium oxide powder catalyst supporting Rh metal/oxides thereon in an amount of 0.5% by weight in terms of rhodium based on the catalyst was prepared in the same manner as in Example 1, except for using the cerium hydroxide and 33.60 g of the rhodium nitrate solution. The cerium oxide powder catalyst was supported on the same honeycomb substrate of cordierite as in Example 1 to provide a honeycomb catalyst structure supporting the catalyst in an amount of about 150 g/l. The thickness of the catalyst layer was about 40 μm. This catalyst is designated as Catalyst 4.

### EXAMPLE 5

In the same manner of Example 3, a honeycomb catalyst structure supporting the catalyst of 1.5% Rh supported on zirconia in an amount of about 120 g/l. The thickness of the catalyst layer was about 30 μm. Furthermore, sixty six grams of the zirconium hydroxide powder (RSD from Daiichi Kigenso Kogyo) were mixed with 6 g of silica sol (Snowtex N available from Nissan Kagaku Kogyo K. K.) and an appropriate amount of water. The mixture was ground with a planetary mill for five minutes using 100 g of zirconia balls as grinding media to prepare a wash-coat slurry. Then, the honeycomb catalyst structure supporting the catalyst of 1.5% Rh supported on zirconia was additionally coated with the slurry containing zirconium hydroxide to provide a honeycomb catalyst structure supporting the zirconium hydroxide in an amount of about 30 g/l (8 μm). The honeycomb was calcined at 500° C. for three hours in air. This catalyst is designated as Catalyst 5.

### EXAMPLE 6

In the same manner of Example 5, a honeycomb catalyst structure supporting the catalyst of 1.5% Rh supported on zirconia in an amount of about 100 g/l (27 μm). In the same manner of Example 5, the honeycomb catalyst structure supporting the catalyst of 1.5% Rh supported on zirconia was additionally coated with the slurry containing zirconium hydroxide to provide a honeycomb catalyst structure supporting the zirconium hydroxide in an amount of about 150 g/l. The honeycomb was calcined at 500° C. for three hours in air. The total thickness of the catalyst layer was about 40 μm. This catalyst is designated as Catalyst 6.

### EXAMPLE 7

In the same manner of Example 3, 60 g of the zirconia powder supported Rh thereon in an amount of 1.5% by weight in terms of rhodium based on the powder. In 1000ml of ion-exchanged water was dissolved 31.7 g of praseodymium nitrate (Pr(NO₃)₃.6H₂O). 0.1N ammonium hydroxide solution was added into the praseodymium nitrate solution to precipitate praseodymium hydroxide. After the addition, the slurry was aged for one hour. The Rh supported zirconia powder additionally supported praseodymium hydroxide (17% Pr₂O₃/1.3% Rh/82.7% ZrO₂) thereon was collected by filtration and thoroughly washed with ion-exchanged water, thereby providing the powder. The powder catalyst was supported on the same honeycomb substrate of cordierite as in Example 1 to provide a honeycomb catalyst structure supporting the catalyst in an amount of about 150 g/l. The honeycomb was calcined at 500° C. for three hours in air. The thickness of the catalyst layer was about 40 μm. This catalyst is designated as Catalyst 7.

### EXAMPLE 8

In 100 ml of ion-exchanged water was dissolved 7.60 g of palladium nitrate solution (8.01 wt % as Pd). Sixty six grams of zirconium/cerium hydroxide (80 wt %/20 wt %) (available from Daiichi Kigenso Kogyo) was dried at 120° C. for 24 hours, and was added to the aqueous solution of rhodium nitrate to provide a slurry. The resulting slurry was dried at 80° C. with a rotary evaporator (Büch, RE111). The zirconium/cerium hydroxide supporting palladium nitrate thereon thus obtained was heated and calcined at 500° C. for one hour in air, thereby providing zirconia-ceria (80/20) powder catalysts supporting palladium metal/oxides thereon in an amount of 1% by weight in terms of palladium based on the catalyst. The powder catalyst was supported on the same honeycomb substrate of cordierite as in Example 1 to provide a honeycomb catalyst structure supporting the catalyst in an amount of about 150 g/l. The thickness of the catalyst layer was about 40 μm. This catalyst is designated as Catalyst 8.

### EXAMPLE 9

The zirconia powder catalyst supporting Rh/Pd metal/oxides thereon in an amount of 0.8/0.2% by weight in terms of Rh/Pd based on the catalyst was prepared in the same manner as in Example 8, except for using 53.76 g of the rhodium nitrate solution and 1.52 g of the palladium nitrate solution. The powder catalyst was supported on the same honeycomb substrate of cordierite as in Example 1 to provide a honeycomb catalyst structure supporting the catalyst in an amount of about 150 g/l. The thickness of the catalyst layer was about 40 μm. This catalyst is designated as Catalyst 9.

### EXAMPLE 10

In 1000 ml of ion-exchanged water was dissolved 156.33 g of neodymium nitrate (Nd(NO₃)₃.6H₂O). 0.1N ammonium hydroxide solution was added into the nitrate solution to precipitate neodymium hydroxide from neodymium nitrate. After the addition, the slurry was aged for one hour. The neodymium hydroxide was collected by filtration and thoroughly washed with ion-exchanged water, thereby providing a neodymium hydroxide powder. A neodymium oxide powder catalyst supporting Rh metal/oxides thereon in an amount of 0.5% by weight in terms of rhodium based on the catalyst was prepared in the same manner as in Example 1, except for using the neodymium hydroxide and 33.60 g of the rhodium nitrate solution. The neodymium oxide powder catalyst was supported on the same honeycomb substrate of cordierite as in Example 1 to provide a honeycomb catalyst structure supporting the catalyst in an amount of about 150 g/l. The thickness of the catalyst layer was about 40 μm. This catalyst is designated as Catalyst 10.

### EXAMPLE 11

In 1000 ml of ion-exchanged water was dissolved 105.96 g of cerium nitrate (Ce(NO₃)₃.6H₂O) and 47.55 g of praseodymium nitrate (Pr(NO₃)₃.6H₂O). 0.1N ammonium hydroxide solution was added into the cerium nitrate solution to precipitate cerium/praseodymium hydroxides from cerium/praseodymium nitrates. After the addition, the slurry was aged for one hour. The cerium/praseodymium hydroxide was collected by filtration and thoroughly washed with ion-exchanged water, thereby providing a cerium/praseodymium hydroxide powder. A cerium/praseodymium oxide (70/30 wt %) powder catalyst supporting Rh metal/oxides thereon in an amount of 0.5% by weight in terms of rhodium based on the catalyst was prepared in the same manner as in Example 1, except for using the cerium/praseodymium hydroxide and 33.60 g of the rhodium nitrate solution. The cerium/praseodymium oxide powder catalyst was supported on the same honeycomb substrate of cordierite as in Example 1 to provide a honeycomb catalyst structure supporting the catalyst in an amount of about 150 g/l. The thickness of the catalyst layer was about 40 μm. This catalyst is designated as Catalyst 11.

### EXAMPLE 12 (COMPARATIVE)

A γ-alumina powder catalyst supporting rhodium ions thereon in an amount of 0.25% by weight based on the catalyst was prepared in the same manner as in Example 1, using a γ-alumina powder (KC-501 available from Sumitomo Kagaku Kogyo K. K). The γ-alumina powder catalyst was coated on a honeycomb substrate of cordierite to provide a honeycomb catalyst structure supporting the powder catalyst in an amount of about 150 g/l. The thickness of the catalyst layer was about 40 μm. This catalyst is designated as Catalyst 12.

### EXAMPLE 13 (COMPARATIVE)

The zirconia powder catalyst supporting Pt metal/oxides thereon in an amount of 1% by weight in terms of Pt based on the catalyst was prepared in the same manner as in Example 8, except for using 24.40 g of the tetra amine platinum nitrate solution (2.55 wt % as Pt). The zirconia powder catalyst was supported on the same honeycomb substrate of cordierite as in Example 1 to provide a honeycomb catalyst structure supporting the catalyst in an amount of about 150 g/l. The thickness of the catalyst layer was about 40 μm. This catalyst is designated as Catalyst 13.

### EXAMPLE 14 (COMPARATIVE)

A zirconia powder catalyst supporting Rh metal/oxides thereon in an amount of 0.01% by weight in terms of rhodium based on the catalyst was prepared in the same manner as in Example 1, except for using 0.67 g of the rhodium nitrate solution. The zirconia powder catalyst was supported on the same honeycomb substrate of cordierite as in Example 1 to provide a honeycomb catalyst structure supporting the catalyst in an amount of about 150 g/l. The thickness of the catalyst layer was about 40 μm. This catalyst is designated as Catalyst 14.

### EXAMPLE 15 (COMPARATIVE)

In 100 ml of ion-exchanged water was dissolved 30.40 g of palladium nitrate solution (8.01 wt % as Pd). Sixty six grams of zirconium hydroxide (RSD available from Daiichi Kigenso Kogyo) was dried at 120° C. for 24 hours, and was added to the aqueous solution of rhodium nitrate to provide a slurry. The resulting slurry was dried at 80° C. with a rotary evaporator (Büchi, RE111). The zirconium hydroxide supporting palladium nitrate thereon thus obtained was heated and calcined at 500° C. for one hour in air, thereby providing zirconia powder catalysts supporting palladium metal/oxides thereon in an amount of 4% by weight in terms of palladium based on the catalyst. The zirconia powder catalyst was supported on the same honeycomb substrate of cordierite as in Example 1 to provide a honeycomb catalyst structure supporting the catalyst in an amount of about 150 g/l. The thickness of the. catalyst layer was about 40 μm. This catalyst is designated as Catalyst 15.

(2) Performance Tests

Using the catalysts (1 to 10 and 11) and the comparative catalysts (12 to 13 and 14), a nitrogen oxide containing gas was reduced under the conditions below. The conversion of nitrogen oxides, to nitrogen was determined by a chemical luminescence method.

Test Methods:

The mixture for the NOx reduction experiment under a rich condition comprised of 500 ppm of NO, 40 ppm of SO₂, 0.4% of O₂, 2% of CO, 2000 ppm of C₃H₆, 9.0% of H₂O and 2% of H₂. The gas composition under a lean condition was composed of 456 ppm of NO, 37 ppm of SO₂, 9.2% of O₂, 1.8% of CO, 1822 ppm of C₃H₆, 8.2% of H₂O and 1.8% of H₂ and it was prepared by injecting oxygen into the mixture under the rich condition. Catalyst was examined in the catalytic reaction with an oscillation between the rich and lean conditions, periodically at 10-120 seconds intervals (perturbed scan) and 1/10 of the ratio of rich/lean time spans, as shown with an example in FIG. 1.

(i) Space Velocity: 100,000⁻¹ hr (under the lean condition); 99,017 hr⁻¹ (under the rich condition)

(iii) Reaction Temperature:

250, 300, 350, 400, 450 or 500° C.

The results are shown in Table 1.

As is apparent from Table 1, the catalysts of the invention achieves high conversion of nitrogen oxides, whereas the comparative catalysts have on the whole a low conversion rate of nitrogen oxides. In addition, the catalysts of the invention are durable even when they are used at high temperatures and show excellent in resistance to sulfur oxides.

TABLE 1
The results of Rh, Pd/Zr, Ce, Nd, Pr oxide catalysts

| | Rich/ | | | | | | | |
|---|---|---|---|---|---|---|---|---|
| | lean | | | | | | | |
| | spans | Temperature (° C.) | | | | | | |
| Catalyst | (sec.) | 200 | 250 | 300 | 350 | 400 | 450 | 500 |
| Catalyst 1 | 0.5/5 | 97.9 | 99.9 | 99.9 | 99.8 | 98.5 | 93.7 | 85.3 |
| | 3/30 | 94.3 | 99.8 | 99.6 | 98.9 | 93.5 | 89.2 | 78.1 |
| | 6/60 | 85.6 | 91.7 | 92.1 | 90.7 | 88.4 | 75.7 | 67.0 |
| | 12/120 | 37.5 | 43.8 | 47.0 | 37.9 | 30.4 | 18.6 | 9.7 |
| Catalyst 2 | 6/60 | 95.6 | 96.4 | 96.6 | 95.5 | 92.6 | 88.0 | 83.3 |
| Catalyst 3 | 6/60 | 96.8 | 97.3 | 97.5 | 93.4 | 89.4 | 83.2 | 71.6 |
| Catalyst 4 | 6/60 | 97.0 | 98.9 | 98.5 | 95.3 | 94.9 | 90.1 | 88.8 |
| Catalyst 5 | 6/60 | 97.5 | 98.7 | 99.1 | 94.5 | 93.2 | 92.0 | 87.4 |
| Catalyst 6 | 6/60 | 97.9 | 98.9 | 99.3 | 95.2 | 93.6 | 92.5 | 88.1 |
| Catalyst 7 | 6/60 | 99.1 | 99.5 | 99.9 | 99.5 | 98.4 | 96.9 | 93.0 |
| Catalyst 8 | 6/60 | 97.8 | 98.9 | 96.7 | 94.2 | 89.3 | 82.9 | 70.3 |
| Catalyst 9 | 6/60 | 96.1 | 96.3 | 96.9 | 93.9 | 90.1 | 87.3 | 80.2 |
| Catalyst 10 | 6/60 | 95.4 | 96.1 | 96.7 | 92.3 | 93.0 | 87.8 | 83.5 |
| Catalyst 11 | 6/60 | 97.2 | 98.4 | 98.9 | 96.4 | 94.6 | 90.7 | 86.5 |
| Catalyst 12 | 6/60 | 0.0 | 0.0 | 5.7 | 12.0 | 27.5 | 36.2 | 51.4 |
| Catalyst 13 | 6/60 | 28.8 | 24.5 | 20.9 | 18.7 | 4.0 | 2.2 | 0.0 |
| Catalyst 14 | 6/60 | 24.5 | 21.1 | 15.6 | 6.3 | 1.8 | 0.0 | 0.0 |
| Catalyst 15 | 6/60 | 48.8 | 59.3 | 58.9 | 51.4 | 49.3 | 47.6 | 37.8 |

### B. SECOND MAIN EMBODIMENT (Rh, Pd/Zr, Ce, Nd, Pr OXIDE OUTER LAYER +Rh, Pd, Pt INNER LAYER)

(1) Preparation of the Catalyst

Preparation of Powder Catalyst

(i) Three Way Catalyst

### EXAMPLE 16

In 100 ml of ion-exchanged water was dissolved 8.40 g of palladium nitrate solution (9.0 wt % as Pd) and 4.20 g of rhodium nitrate solution (9.0 wt % as Rh) and 8.40 g of tetra-ammonium platinum nitrate (9.0 wt % as Pt). Sixty grams of a γ-alumina powder (KC-501 available from Sumitomo Kagaku Kogyo K. K.) was added to the aqueous solution of palladium nitrate, followed by drying at 100° C. with agitation and calcining at 500° C. for 3 hours to provide a powder catalyst. A powder catalyst supporting Pd, Rh and Pt metal/oxides on γ-alumina in an amount of 1.0, 0.5 and 1.0 wt %, respectively by weight in terms of palladium, rhodium and platinum based on the catalyst was prepared.

### EXAMPLE 17

In 100 ml of ion-exchanged water was dissolved 8.40 g of rhodium nitrate solution (9.0 wt % as Rh) and 4.20 g of tetra-ammonium platinum nitrate (9.0 wt % as Pt). Sixty grams of a silica-alumina powder (SIRAL 1 available from CONDEA Chemie GmbH) was added to the aqueous solution of palladium nitrate, followed by drying at 100° C. with agitation and calcining at 500° C. for 3 hours to provide a powder catalyst. The silica-alumina powder catalyst contained 1.0 wt % Pt and 0.5 wt % Rh.

### EXAMPLE 18

In 100 ml of ion-exchanged water was dissolved 16.80 g of palladium nitrate solution (9.0 wt % as Pd). Sixty grams of a γ-alumina powder (KC-501 available from Sumitomo Kagaku Kogyo K. K.) was added to the aqueous solution of palladium nitrate, followed by drying at 100° C. with agitation and calcining at 500° C. for 3 hours to provide a powder catalyst. A powder catalyst supporting Pd metal/oxides on γ-alumina in an amount of 2% by weight in terms of palladium based on the catalyst was prepared.

(ii) DeNOx Catalyst

### EXAMPLE 19

In 1000 ml of ion-exchanged water was dissolved 151.37 g of cerium nitrate (Ce(NO₃)₃.6H₂O). 0.1N ammonium hydroxide solution was added into the cerium nitrate solution to precipitate cerium hydroxide from cerium nitrate. After the addition, the slurry was aged for one hour. The cerium hydroxide was collected by filtration and thoroughly washed with ion-exchanged water, thereby providing a cerium hydroxide powder. In 100 ml of ion-exchanged water was dissolved 90.00 g of rhodium nitrate solution (0.90 wt % as Rh). Sixty six grams of cerium hydroxide was dried at 120° C. for 24 hours, and was added to the aqueous solution of rhodium nitrate to provide a slurry. One-tenth normal (0.1 N) ammonia water was added dropwise to the slurry with stirring while the slurry was maintained at a pH of about 4 with a pH controller. After the addition, the slurry was aged for one hour, thereby providing cerium hydroxide supporting rhodium ions thereon. The cerium hydroxide supporting rhodium ions thereon thus obtained was collected by filtration and thoroughly washed with ion-exchanged water, thereby providing a cerium hydroxide powder supporting rhodium thereon in an amount of 1.4% by weight in terms of rhodium based on the powder. The ceria supporting rhodium thereon thus obtained was heated and calcined at 500° C. for three hours in air, thereby providing a ceria powder catalyst supporting Rh metal/oxides thereon in an amount of 1.5% by weight in terms of rhodium based on the catalyst.

### EXAMPLE 20

In 100 ml of ion-exchanged water was dissolved 15.20 g of palladium nitrate solution (8.01 wt % as Pd). Sixty six grams of zirconium/cerium hydroxide (80 wt %/20 wt %) (available from Daiichi Kigenso Kogyo) was dried at 120° C. for 24 hours, and was added to the aqueous solution of rhodium nitrate to provide a slurry. The resulting slurry was dried at 80° C. with a rotary evaporator (Büchi, RE 111). The zirconium/cerium hydroxide supporting palladium nitrate thereon thus obtained was heated and calcined at 500° C. for one hour in air, thereby providing zirconia/ceria powder catalysts supporting palladium metal/oxides thereon in an amount of 2% by weight in terms of palladium based on the catalyst.

### EXAMPLE 21

In 1000 ml of ion-exchanged water was dissolved 105.96 g of cerium nitrate (Ce(NO₃)₃.6H₂O) and 47.55 g of praseodymium nitrate (Pr(NO₃)₃.6H₂O). 0.1N ammonium hydroxide solution was added into the cerium nitrate solution to precipitate cerium/praseodymium hydroxides from cerium/praseodymium nitrates. After the addition, the slurry was aged for one hour. The cerium/praseodymium hydroxide was collected by filtration and thoroughly washed with ion-exchanged water, thereby providing a cerium/praseodymium hydroxide powder. A cerium/praseodymium oxide (70/30 wt %) powder catalyst supporting Rh metal/oxides thereon in an amount of 0.5% by weight in terms of rhodium based on the catalyst was prepared in the same manner as in Example 16, except for using the cerium/praseodymium hydroxide and 33.60 g of the rhodium nitrate solution.

### EXAMPLE 22

In 100 ml of ion-exchanged water was dissolved 7.60 g of palladium nitrate solution (8.01 wt % as Pd) and 33.60 g of rhodium nitrate (0.9 wt % as Rh). Sixty six grams of zirconium/cerium hydroxide (20 wt %/80 wt %) (available from Rhodia) was dried at 120° C. for 24 hours, and was added to the aqueous solution of palladium and rhodium nitrate to provide a slurry. The resulting slurry was dried at 80° C. with a rotary evaporator (Büchi, RE111). The zirconium/cerium hydroxide supporting palladium and rhodium nitrate thereon thus obtained was heated and calcined at 500° C. for one hour in air, thereby providing zirconia/ceria powder catalysts supporting palladium and rhodium metal/oxides thereon in an amount of 1% and 0.5%, respectively by weight in terms of palladium based on the catalyst.

### EXAMPLE 23

In 1000 ml of ion-exchanged water was dissolved 156.33 g of neodymium nitrate (Nd(NO₃)₃.6H₂O ). 0.1N ammonium hydroxide solution was added into the nitrate solution to precipitate neodymium hydroxide from neodymium nitrate. After the addition, the slurry was aged for one hour. The neodymium hydroxide was collected by filtration and thoroughly washed with ion-exchanged water, thereby providing a neodymium hydroxide powder. A neodymium oxide powder catalyst supporting Rh metal/oxides thereon in an amount of 0.5% by weight in terms of rhodium based on the catalyst was prepared in the same manner as in Example 16, except for using the neodymium hydroxide and 33.60 g of the rhodium nitrate solution.

### EXAMPLE 24

In 100 ml of ion-exchanged water was dissolved 134.60 g of rhodium nitrate (0.9wt % as Rh). Sixty six grams of cerium oxide HSA10 with 200 m²/g of specific surface area (available from Rhodia) was dried at 120° C. for 24 hours, and was added to the aqueous solution of rhodium nitrate to provide a slurry. The resulting slurry was dried at 80° C. with a rotary evaporator (Büchi, RE111). The ceria supporting rhodium nitrate thereon thus obtained was heated and calcined at 500° C. for one hour in air, thereby providing ceria powder catalysts supporting rhodium metal/oxides thereon in an amount of 1.5% by weight in terms of rhodium based on the catalyst.

(iii) Honeycomb Catalyst

The thickness of the catalyst layers was calculated as follows:

$$Thickness ( µm ) = \frac{cw \times {10}^{2}}{Vol . \times density \times Ap}$$

, wherein cw means the coating weight in grams, Vol. is the catalyst volume in litres, density is the catalyst density in g/cm³, and Ap is the area performance of the catalyst in m²/m³. In main embodiment 2, when the coating weight per catalyst volume is about 75 g/l, the density of the layer is 1 g/cm³ and the area performance of the honeycomb or corresponding structure is 2500 m²/m³, the thickness is about 30 μm.

### EXAMPLE 25

Sixty grams of the powder catalyst supporting Pd, Rh and Pt metal/oxides on γ-alumina in an amount of 1.0, 0.5 and 1.0 wt %, respectively by weight in terms of palladium, rhodium and platinum based on the catalyst, which was prepared in Example 16, were mixed with 6 g of silica sol (Snowtex N available from Nissan Kagaku Kogyo K. K.) and an appropriate amount of water. The mixture was ground with a planetary mill for five minutes using 100 g of zirconia balls as grinding media to prepare a wash-coat slurry. A honeycomb substrate of cordierite having a cell number of 400 per square inch was coated with the slurry to provide a honeycomb catalyst structure supporting the catalyst with the thickness of 40 μm (100 g/l). Furthermore, sixty grams of the ceria powder catalyst supporting Rh metal/oxides thereon in an amount of 1.5% by weight in terms of rhodium based on the catalyst, which was prepared in Example 19, were mixed with 6 g of silica sol (Snowtex N available from Nissan Kagaku. Kogyo K. K.) and an appropriate amount of water. The mixture was ground with a planetary mill for five minutes using 100 g of zirconia balls as grinding media to prepare a wash-coat slurry. The honeycomb, which was coated with the powder catalyst supporting Pd, Rh and Pt metal/oxides on γ-alumina, was additionally coated with the slurry to provide a honeycomb catalyst structure coating the ceria catalyst supporting Rh metal/oxides with the thickness of 60 μm (150 g/l ) on the 1% Pd/0.5%Rh/1% Pt/γ-alumina. This catalyst is designated as Catalyst 16.

### EXAMPLE 26

Following the procedure of Example 25, a honeycomb catalyst was prepared. The catalyst has an inner layer catalyst of the Pd, Rh and Pt metal/oxides on γ-alumina catalyst with the thickness of 30 μm (75 g/l) and an outer catalyst of the Rh/ceria catalyst with the thickness of 60 μm (150 g/l). This catalyst is designated as Catalyst 17.

### EXAMPLE 27

Following the procedure of Example 25, a honeycomb catalyst was prepared. The catalyst has an inner layer catalyst of the Pd, Rh and Pt metal/oxides on γ-alumina catalyst with the thickness of 30 μm (75 g/l) and an outer catalyst of the Rh/ceria catalyst with the thickness of 30 μm (75 g/l). This catalyst is designated as Catalyst 18.

### EXAMPLE 28

Sixty grams of the powder catalyst composed of 1.0 wt % Pt and 0.1 wt % Rh supported on silica-alumina, which was prepared in Example 17, were mixed with 6 g of silica sol (Snowtex N available from Nissan Kagaku Kogyo K. K.) and an appropriate amount of water. The mixture was ground with a planetary mill for five minutes using 100 g of zirconia balls as grinding media to prepare a wash-coat slurry. A honeycomb substrate of cordierite having a cell number of 400 per square inch was coated with the slurry to provide a honeycomb catalyst structure supporting the catalyst with the thickness of 30 μm (75 g/l). Furthermore, sixty grams of the ceria powder catalyst supporting Rh metal/oxides thereon in an amount of 1.5% by weight in terms of rhodium based on the catalyst, which was prepared in Example 19, were mixed with 6 g of silica sol (Snowtex N available from Nissan Kagaku Kogyo K. K.) and an appropriate amount of water. The mixture was ground with a planetary mill for five minutes using 100 g of zirconia balls as grinding media to prepare a wash-coat slurry. The honeycomb, which was coated with the 1.0% Pt/0.5% Rh supported on silica-alumina, was additionally coated with the slurry to provide a honeycomb catalyst structure supporting the ceria catalyst coating Rh metal/oxides with the thickness of 60 μm (150 g/l) on the 1% Pt/0.5% Rh/silica-alumina. This catalyst is designated as Catalyst 19.

### EXAMPLE 29

Sixty grams of the powder catalyst composed of Pd metal/oxides on γ-alumina in an amount of 2% by weight in terms of palladium based on the catalyst, which was prepared in Example 18, were mixed with 6 g of silica sol (Snowtex N available from Nissan Kagaku Kogyo K. K.) and an appropriate amount of water. The mixture was ground with a planetary mill for five minutes using 100 g of zirconia balls as grinding media to prepare a wash-coat slurry. A honeycomb substrate of cordierite having a cell number of 400 per square inch was coated with the slurry to provide a honeycomb catalyst structure supporting the catalyst with the thickness of 30 μm (75 g/l). Furthermore, sixty grams of the ceria powder catalyst supporting Rh metal/oxides thereon in an amount of 1.5% by weight in terms of rhodium based on the catalyst, which was prepared in Example 19, were mixed with 6 g of silica sol (Snowtex N available from Nissan Kagaku Kogyo K. K.) and an appropriate amount of water. The mixture was ground with a planetary mill for five minutes using 100 g of zirconia balls as grinding media to prepare a wash-coat slurry. The honeycomb, which was coated with the 2.0% Pd supported on γ-alumina, was additionally coated with the slurry to provide a honeycomb catalyst structure coating the ceria supporting Rh metal/oxides with the thickness of 60 μm (150 g/l ) on the 2% Pd/γ-alumina. This catalyst is designated as Catalyst 20.

### EXAMPLE 30

Sixty grams of the powder catalyst supporting Pd, Rh and Pt metal/oxides on γ-alumina in an amount of 1.0, 0.5 and 1.0 wt %, respectively by weight in terms of palladium, rhodium and platinum based on the catalyst, which was prepared in Example 16, were mixed with 6 g of silica sol (Snowtex N available from Nissan Kagaku Kogyo K. K.) and an appropriate amount of water. The mixture was ground with a planetary mill for five minutes using 100 g of zirconia balls as grinding media to prepare a wash-coat slurry. A honeycomb substrate of cordierite having a cell number of 400 per square inch was coated with the slurry to provide a honeycomb catalyst structure supporting the catalyst with the thickness of 40 μm (100 g/l). Furthermore, sixty grams of the zirconia/ceria catalyst supporting palladium metal/oxides thereon in an amount of 2% by weight in terms of palladium based on the catalyst, which was prepared in Example 20, were mixed with 6 g of silica sol (Snowtex N available from Nissan Kagaku Kogyo K. K.) and an appropriate amount of water. The mixture was ground with a planetary mill for five minutes using 100 g of zirconia balls as grinding media to prepare a wash-coat slurry. The honeycomb, which was coated with the powder catalyst supporting Pd, Rh and Pt metal/oxides on γ-alumina, was additionally coated with the slurry to provide a honeycomb catalyst structure coating the zirconia/ceria powder catalyst supporting Pd metal/oxides with the thickness of 60 μm (150 g/l) on the 1% Pd/0.5% Rh/1% Pt/γ-alumina. This catalyst is designated as Catalyst 21.

### EXAMPLE 31

Following the procedure of Example 25, a honeycomb substrate of cordierite having a cell number of 400 per square inch was coated with the slurry to provide a honey-comb catalyst structure supporting the 1% Pd/0.5% Rh/1% Pt/γ-alumina catalyst with the thickness of 40 μm (100 g/l). Furthermore, cerium/praseodymium oxide (70/30 wt %) catalyst supporting Rh metal/oxides thereon in an amount of 0.5% by weight in terms of rhodium based on the catalyst, which was prepared in Example 21, was additionally coated on the honeycomb coating the 1% Pd/0.5% Rh/1% Pt/γ-alumina catalyst with the thickness of 60 μm (150 g/l) in the same way as in Example 25. This catalyst is designated as Catalyst 22.

### EXAMPLE 32

Following the procedure of Example 25, a honeycomb substrate of cordierite having a cell number of 400 per square inch was coated with the slurry to provide a honey-comb catalyst structure supporting the 1% Pd/0.5% Rh/1% Pt/γ-alumina catalyst with the thickness of 40 μm (100 g/l). Furthermore, zirconia/ceria powder catalysts supporting palladium and rhodium metal/oxides thereon in an amount of 1.5% by weight in terms of rhodium based on the catalyst, which was prepared in Example 22, was additionally coated on the honeycomb coating the 1% Pd/0.5% Rh/1% Pt/γ-alumina catalyst with the thickness of 60 μm (150 g/l) in the same way as in Example 25. This catalyst is designated as Catalyst 23.

### EXAMPLE 33

Following the procedure of Example 25, a honeycomb substrate of cordierite having a cell number of 400 per square inch was coated with the slurry to provide a honeycomb catalyst structure supporting the 1% Pd/0.5% Rh/1% Pt/γ-alumina catalyst with the thickness of 40 μm (100 g/l). Furthermore, neodymium oxide powder catalyst supporting Rh metal/oxides thereon in an amount of 0.5% by weight in terms of rhodium based on the catalyst which was prepared in Example 23, was additionally coated on the honeycomb coating the 1% Pd/0.5% Rh/1% Pt/γ-alumina catalyst with the thickness of 60 μm (150 g/l) in the same way as in Example 25. This catalyst is designated as Catalyst 24.

### EXAMPLE 34

Following the procedure of Example 25, a honeycomb substrate of cordierite having a cell number of 400 per square inch was coated with the slurry to provide a honey-comb catalyst structure supporting the 1% Pd/0.5% Rh/1% Pt/γ-alumina catalyst with the thickness of 40 μm (100 g/l). Furthermore, high surface area-ceria powder catalyst supporting Rh metal/oxides thereon in an amount of 1.5% by weight in terms of rhodium based on the catalyst, which was prepared in Example 24, was additionally coated on the honeycomb coating the 1% Pd/0.5% Rh/1% Pt/γ-alumina catalyst with the thickness of 60 μm (150 g/l) in the same way as in Example 25. This catalyst is designated as Catalyst 25.

### EXAMPLE 34-1

Following the procedure of Example 25, a honeycomb catalyst with the inner layer catalyst of the Pd, Rh and Pt meta/oxides on γ-alumina catalyst with the thickness of 20 μm (50 g/l). Furthermore, 60 g of cerium/zirconium/praseodymium oxides (47 wt %/33 wt %/22 wt % as CeO₂/ZrO₂/Pr₆O₁₁ available from Rhodia Electronics & Catalysis) thereon in an amount of 1.5% by weight in terms of rhodium based on the catalyst, which was prepared using cerium/zirconium/praseodymium oxides instead of ceria following the procedure of Example 19, were mixed with 6 g of silica sol (Snowtex N available from Nissan Kagaku Kogyo K. K.) and an appropriate amount of water. After that, a wash of coat slurry was prepared following the procedure of Example 25. The honeycomb, which was coated with the powder catalyst supporting Pd, Rh and Pt metal/oxide on y-alumina, was additionally coated with the slurry to provide a honeycomb catalyst structure coating the cerium/zirconium/praseodymium oxides catalyst supporting Rh metal/oxides with the thickness of 60 μm (150 g/l) on the 1% Pd/0.5Rh/1% Pt/γ-alumina. This catalyst is designated as Catalyst 25-1.

### Example 34-2

Following the procedure of Example 25, a honeycomb catalyst with the inner layer catalyst of the Pd, Rh and Pt meta/oxides on γ-alumina catalyst with the thickness of 20 μm (50 g/l). Furthermore, 60 g of cerium/zirconium/neodymium oxides (70 wt %/20 wt %/10 wt % as CeO₂/ZrO₂/Nd₂O₃ available from Rhodia Electronics & Catalysis) thereon in an amount of 1.5% by weight in terms of rhodium based on the catalyst, which was prepared using cerium/zirconium/praseodymium oxides instead of ceria following the procedure of Example 19, were mixed with 6 g of silica sol (Snowtex N available from Nissan Kagaku Kogyo K. K.) and an appropriate amount of water. After that, a wash of coat slurry was prepared following the procedure of Example 25. The honeycomb, which was coated with the powder catalyst supporting Pd, Rh and Pt metal/oxide on γ-alumina, was additionally coated with the slurry to provide a honeycomb catalyst structure coating the cerium/zirconium/praseodymium oxides catalyst supporting Rh metal/oxides with the thickness of 60 μm (150 g/l) on the 1% Pd/0.5Rh/1% Pt/γ-alumina. This catalyst is designated as Catalyst 25-2.

### EXAMPLE 35 (COMPARATIVE)

Sixty grams of the powder catalyst supporting Pd, Rh and Pt metal/oxides on alumina in an amount of 1.0, 0.5 and 1.0 wt %, respectively by weight in terms of palladium, rhodium and platinum based on the catalyst, which was prepared in Example 16, were mixed with 6 g of silica sol (Snowtex N available from Nissan Kagaku Kogyo K. K.) and an appropriate amount of water. The mixture was ground with a planetary mill for five minutes using 100 g of zirconia balls as grinding media to prepare a wash-coat slurry. A honeycomb substrate of cordierite having a cell number of 400 per square inch was coated with the slurry to provide a honeycomb catalyst structure supporting the catalyst with the thickness of 80 μm (200 g/l). This catalyst is designated as Catalyst 26.

### EXAMPLE 36 (COMPARATIVE)

Sixty grams of the ceria powder catalyst supporting Rh metal/oxides thereon in an amount of 1.5%, which was prepared in Example 19, were mixed with 6 g of silica sol (Snowtex N available from Nissan Kagaku Kogyo K. K.) and an appropriate amount of water. The mixture was ground with a planetary mill for five minutes using 100 g of zirconia balls as grinding media to prepare a wash-coat slurry. A honeycomb substrate of cordierite having a cell number of 400 per square inch was coated with the slurry to provide a honeycomb catalyst structure supporting the catalyst with the thickness of 80 μm (200 g/l). This catalyst is designated as Catalyst 27.

### EXAMPLE 37 (COMPARATIVE)

Sixty grams of the cerium/praseodymium oxide (70/30 wt %) powder catalyst supporting Rh metal/oxides thereon in an amount of 0.5%, which was prepared in Example 21, were mixed with 6 g of silica sol (Snowtex N available from Nissan Kagaku Kogyo K. K.) and an appropriate amount of water. The mixture was ground with a planetary mill for five minutes using 100 g of zirconia balls as grinding media to prepare a wash-coat slurry. A honeycomb substrate of cordierite having a cell number of 400 per square inch was coated with the slurry to provide a honeycomb catalyst structure supporting the catalyst with the thickness of 80 μm (200 g/l). This catalyst is designated as Catalyst 28.

### EXAMPLE 38

Sixty grams of the ceria powder catalyst supporting rhodium metal/oxides thereon in an amount of 1.5%, which was prepared in Example 24, were mixed with 6 g of silica sol (Snowtex N available from. Nissan Kagaku Kogyo K. K.) and an appropriate amount of water. The mixture was ground with a planetary mill for five minutes using 100 g of zirconia balls as grinding media to prepare a wash-coat slurry. A honeycomb substrate of cordierite having a cell number of 400 per square inch was coated with the slurry to provide a honeycomb catalyst structure supporting the catalyst with the thickness of 80 μm (200 g/l). This catalyst is designated as Catalyst 29.

(2) Performance Tests

Using the catalysts (16 to 25 and 26) and the comparative catalysts (27, 28 and 29), a nitrogen oxide containing gas was reduced under the conditions below. The conversion of nitrogen oxides to nitrogen was determined by a chemical luminescence method.

Test Methods:

The mixture for the NOx reduction experiment under a rich condition comprised of 200 ppm of NO, 40 ppm of SO₂, 0.4% of O₂, 2% of CO, 2000 ppm of C₃H₆, 9.0% of H₂O and 2% of H₂. The gas composition under a lean condition was composed of 182 ppm of NO, 37 ppm of SO₂, 9.2% of O₂, 0.1% of CO, 100 ppm of C₃H₆, 8.2% of H₂O and 0.1% of H₂ and it was prepared by injecting oxygen into the mixture under the rich condition. Catalyst was examined in the catalytic reaction with an oscillation between the rich and lean conditions, periodically at 10-120 seconds intervals (perturbed scan) and 1/10 of the ratio of rich/lean time spans, as shown with an example in FIG. 1.

(i) Space Velocity: 100,000 hr⁻¹ (under the lean condition); 99,017 hr⁻¹ (under the rich condition).

(iii) Reaction Temperature:

200, 250, 300, 350, 400, 450 or 500° C.

The results are shown in Table 2.

TABLE 2
The results of the Rh, Pd/Zr, Ce, Nd, Pd oxide outer layer - Rh, Pd,
Pt inner layer catalyst

| | Rich/ | | | | | | | |
|---|---|---|---|---|---|---|---|---|
| | lean | | | | | | | |
| | spans | Temperature (° C.) | | | | | | |
| Catalyst | (sec.) | 200 | 250 | 300 | 350 | 400 | 450 | 500 |
| Catalyst 16 | 3/30 | 90.2 | 97.2 | 99.0 | 98.7 | 95.1 | 89.5 | 77.2 |
| | 6/60 | 81.6 | 89.4 | 96.6 | 92.5 | 87.6 | 76.7 | 63.0 |
| | 12/120 | 31.8 | 44.5 | 46.1 | 36.4 | 36.2 | 15.2 | 7.9 |
| Catalyst 17 | 6/60 | 81.0 | 88.5 | 96.2 | 92.1 | 85.3 | 72.1 | 57.8 |
| Catalyst 18 | 6/60 | 65.1 | 77.9 | 84.6 | 78.0 | 70.7 | 66.4 | 48.2 |
| Catalyst 19 | 6/60 | 79.5 | 83.1 | 92.6 | 88.3 | 82.8 | 73.0 | 65.4 |
| Catalyst 20 | 6/60 | 67.8 | 75.9 | 83.7 | 81.9 | 74.5 | 52.4 | 33.3 |
| Catalyst 21 | 6/60 | 72.3 | 82.1 | 80.0 | 75.7 | 68.3 | 55.6 | 39.8 |
| Catalyst 22 | 6/60 | 77.0 | 88.7 | 95.6 | 98.7 | 95.3 | 85.9 | 64.5 |
| Catalyst 23 | 6/60 | 64.3 | 72.9 | 80.7 | 76.3 | 69.0 | 58.7 | 49.6 |
| Catalyst 24 | 6/60 | 78.5 | 89.5 | 84.4 | 78.6 | 72.1 | 65.8 | 57.7 |
| Catalyst 25 | 6/60 | 87.2 | 98.5 | 99.0 | 98.8 | 97.6 | 89.3 | 66.2 |
| Catalyst 25-1 | 6/60 | 63.4 | 79.5 | 92.7 | 95.2 | 93.3 | 83.1 | 62.1 |
| Catalyst 25-2 | 6/60 | 87.6 | 91.1 | 88.1 | 79.6 | 69.7 | 57.3 | 42.5 |
| Catalyst 26 | 6/60 | 33.6 | 20.1 | 13.4 | 0 | 0 | 0 | 0 |
| Catalyst 27 | 6/60 | 52.8 | 62.3 | 64.5 | 61.5 | 55.2 | 45.0 | 33.8 |
| Catalyst 28 | 6/60 | 47.5 | 63.7 | 72.0 | 78.5 | 82.9 | 78.4 | 69.5 |
| Catalyst 29 | 6/60 | 67.0 | 72.8 | 77.8 | 80.1 | 69.3 | 61.4 | 52.7 |

As is apparent from Table 2, the catalysts of the invention achieve high conversion of nitrogen oxides, whereas the comparative catalysts have on the whole a low conversion rate of nitrogen oxides. In addition, the catalysts of the invention are durable even when they are used at high temperatures and show excellent in resistance to sulfur oxides.

1. A method for the catalytic decomposition of nitrogen oxides in exhaust gases by combusting with periodic rich/lean fuel supply excursions and contacting the resulting exhaust gases with a catalyst, characterized in that said excursions consist of a continuous lean fuel supply essentially interrupted by small rich pulses a that the catalyst comprises a first compound, selected from rhodium, palladium, rhodium oxide, palladium oxide and mixtures thereof, and a second compound, selected from zirconia, cerium oxide, praseodymium oxide and/or neodymium oxide and mixtures thereof.

2. A method according to claim 1, characterized in that said first compound is selected from rhodium and rhodium oxide.

3. A method according to claim 1 or 2, characterized in that in the catalyst, the combined amount of said first and said second compound is at least 80%, preferably at least 95%, based on the combined weight of the catalyst.

4. A method according to any preceding claim, characterized in that in the catalyst, the amount of said first compound is 0.05-5% by weight in terms of rhodium and/or palladium, based on the combined weight of said first and said second compound.

5. A method according to 3 or 4 , characterized in that in the catalyst, said second compound supports said first compound.

6. A method according :to claim 5, characterized in that in the catalyst, only a part of said second compound supports said first compound.

7. A method according to claim 6, characterized in that the catalyst has been prepared by applying said first compound on a first portion of said second compound and then applying a second portion of said second compound on said first compound.

8. A method according to any of claims 3-7, characterized in that in the catalyst, the combined first and second compound forms a layer which is no less than 20 μm and preferably at most about 200 μm in thickness.

9. A method according to any of claims 3-8, characterized in that the catalyst has been molded, shaped or deposited into the shape of an exhaust gas catalyst structure, such as a honeycomb, annular or spherical structure.

10. A method according to any of claims 1-9, characterized in that said zirconia, cerium oxide, praseodymium oxide and/or neodymium oxide has been obtained by neutralizing and/or hydrolyzing thermally a zirconium, cerium, praseodymium or neodymium salt, followed by calcining in air or, preferably, said zirconia, cerium oxide, praseodymium oxide and/or neodymium oxide is obtained by calcining a hydroxide compound.

11. A method according to claim 10, characterized in that said zirconium, cerium, praseodymium and/or neodymium salt is neutralized and/or hydrolyzed thermally into zirconia, cerium oxide, praseodymium oxide and/or neodymium oxide hydroxide.

12. A method according to any preceding claim, characterized in that said first compound has been supported on said second compound by contacting in a liquid medium a dissolved Rh and/or Pd salt with solid zirconia, cerium oxide, praseodymium oxide and/or neodymium oxide, preferably by impregnation and/or ion exchange, and then calcining the contacting product.

13. A method according to claim 12, characterized in that said liquid medium is an aqueous medium, the pH of which is maintained at 3 to 5, preferably at about 4.

14. A method according to claim 12 or 13, characterized in that the contacting product is calcined at a temperature of 300-900° C.

15. A method according to claim 1 or 2, characterized in that the catalyst consists essentially of
a. an outer catalyst layer containing said first compound and said second compound and
b. an inner catalyst layer containing a third compound selected from rhodium, platinum, palladium, rhodium oxide, platinum Oxide, palladium oxide, and mixtures thereof

16. A method according to, claim 15, characterized in that said inner catalyst layer contains a support for said third compound.

17. A method according to claim 15 or 16, characterized in that the third compound consists of platinum or platinum oxide and a compound selected from rhodium, palladium, rhodium oxide and palladium oxide.

18. A method according to claim 15, 16 or 17, characterized in that the catalyst system is a two layer structure, the outer catalyst layer forming the outer (contact) surface of the structure and the inner catalyst layer being immediately inside said outer catalyst layer.

19. A method according to any of claims 15-18, characterized in that in the outer catalyst layer, the combined amount of said first and said second compound is at least 80%, preferably at least 95%, based on the total weight of the outer catalyst layer catalyst.

20. A method according to any of claims 15-19, characterized in that in the outer catalyst layer, the amount of said first compound is 0.05-3% by weight in terms of rhodium and/or palladium, based on the combined weight of said first and said second compound.

21. A method according to any of claims 15-20, characterized in that in the outer catalyst layer, said second compound, preferably all of said second compound, supports said first compound.

22. A method according to claim 15-20, characterized in that in the catalyst, only a part of said second compound supports said first compound.

23. A method according to claim 22, characterized in that the catalyst has been prepared by applying said first compound on a first portion of said second compound and then applying a second portion of said second compound on said first compound.

24. A method according to any of claims 15-23, characterized in that the thickness of the outer catalyst layer is ranging from about 20 μm to about 100 μm.

25. A catalyst system according to any of claims 15-24, characterized in that the outer catalyst layer has been formed by preparing an aqueous slurry of at least one of zirconium hydroxide, cerium hydride, praseodymium hydroxide and neodymium hydroxide, contacting the slurry with at least one water soluble salt of rhodium and/or palladium under ion exchange conditions, and calcining the contacting product at about 300° C. to about 900° C.

26. A catalyst system according to any of claims 15-25, characterized in that in the inner catalyst layer, the amount of said rhodium, platinum, palladium, an oxide of them, or any mixture thereof, is 0.05-5% by weight in terms of rhodium, platinum or palladium, the rest preferably being an essentially inert material.

27. A method according to any of claims 15-26, characterized in that in the inner catalyst layer, the amount of said third compound is 0.05-5% by weight in terms of rhodium, platinum or palladium, the rest preferably being an essentially inert material.

28. A method according to any of claims 16-27, characterized in that in the inner catalyst layer, the support for said rhodium, platinum, palladium, an oxide of them, or any mixture thereof, is an inert inorganic oxide, preferably on alumina, silica, silica-alumina, zeolite or a mixture thereof.

29. A method according to any of claims 15-28, characterized in that the thickness of the inner catalyst layer is ranging from about 10 μm to about 80 μm.

30. A method according to any of claims 15-29, characterized in that the inner and outer catalyst layers have been molded, shaped or deposited into the shape of an exhaust gas catalyst structure, such as a honeycomb, annular or spherical structure.

31. A method according to claim 30, characterized in that inner catalyst layer material has been molded, shaped or deposited so as to form said inner catalyst layer having the shape of said exhaust gas catalyst structure, after which outer catalyst layer material has been coated on said inner catalyst layer.

32. A method according to any preceding claim, characterized in that one period of a rich and lean excursion lasts from about 5 to about 120 seconds, preferably from about 10 to about 100 seconds.

33. A method according to any preceding claim, characterized in that the time span of one rich excursion is from about 0.5seconds to about 10 seconds.

34. A method according to any preceding claim, characterized in that the time span of one lean excursion is from about 4.5 seconds to about 90 seconds.

35. A method as claimed in any preceding claim, characterized in that during the rich excursions, the air/gasoline fuel weight ratio is regulated to from about 10 to about 14, preferably so that the resulting exhaust gases contain several hundred volume ppm of nitrogen oxides, 2 to 10 volume % of water, 1 to 5 volume % of carbon monoxide, 1 to 5% of hydrogen, several thousands volume ppm of hydrocarbons and 0 to 0.5% of oxygen.

36. A method as claimed in any preceding claim, characterized in that during the lean excursions, the air/gasoline fuel weight ratio is regulated to from about 20 to about 40, preferably so that the resulting exhaust gases contain several hundred volume ppm of nitrogen oxides, 2 to 10 volume % of water, several thousands volume ppm of carbon monoxide, several thousands volume ppm of hydrogen, several thousands volume ppm of hydrocarbons and 1 to 15% of oxygen.

37. A method as claimed in any preceding claim, characterized in that the resulting exhaust gases are contacted with the catalyst at a temperature of about 150° C. to about 500° C., preferably from about 200° C. to about 450° C.

38. A method as claimed in any preceding claim, characterized in that the resulting exhaust gases are contacted with the catalyst at a space velocity of about 5 000 hr⁻¹ to about 100 000 hr⁻¹ .
